(19) United States
(12) Patent Application Publication
(10) Pub. No.: US 2026/0077667 A1
(43) Pub. Date: Mar. 19, 2026

(54) INFORMATION PROCESSING METHOD, INFORMATION PROCESSING DEVICE, AND NON-TRANSITORY COMPUTER READABLE STORAGE MEDIUM

(71) Applicant: PANASONIC INTELLECTUAL PROPERTY MANAGEMENT CO., LTD., Osaka (JP)

(72) Inventor: Junichi Imoto, Osaka (JP)

(21) Appl. No.: 19/397,056

(22) Filed: Nov. 21, 2025

Related U.S. Application Data
(63) Continuation of application No. PCT/JP2024/019448, filed on May 27, 2024.

(30) Foreign Application Priority Data
May 29, 2023 (JP) 2023-088227

(51) Int. Cl. B60L 53/53; B60L 53/62; B60L 53/66; G06Q 40/04; G06Q 50/06

(52) U.S. Cl. CPC B60L 53/53; B60L 53/62; B60L 53/66; G06Q 40/04; G06Q 50/06

(57) ABSTRACT

This server acquires the remaining power amount of a storage battery possessed by a charging base, a designated time from the present onward, a first actual value that is the actual value of charging power to the storage battery by a renewable energy, and a second actual value that is the actual value of discharge power from the storage battery, predicts, on the basis of the remaining power amount of the storage battery and the second actual value, a necessary power amount that is the charge amount of the storage battery in a period from the present to the designated time, predicts, on the basis of the first actual value, a renewable energy amount that is a power amount by the renewable energy among the necessary power amount, and outputs the renewable energy rate of the storage battery at the designated time on the basis of the renewable energy amount.

### FIELD OF INVENTION

The present disclosure relates to a technique for managing a storage battery charged by power generated by renewable energy.

### BACKGROUND ART

In recent years, there have been an increasing number of charging stations that charge a storage battery with electric power generated in-house by renewable energy such as sunlight and supply the electric power held by the storage battery to an electric moving body such as an electric vehicle (EV).

Along with this, services for providing information regarding charging stations via the Internet are also increasing. For example, Patent Literature 1 describes a technique for providing an electric vehicle with a renewable energy rate, which is a ratio of renewable energy among energy held by a storage battery in a charging station, via a communication line.

However, the technique described in Patent Literature 1 has a problem that although it is possible to grasp the renewable energy currently held by the storage battery in the charging station, it is not possible to grasp how much the storage battery in the charging station will hold the renewable energy in the future.

Patent Literature 1: JP 2017-93289 A

### SUMMARY OF THE INVENTION

The present disclosure has been made to solve such a problem, and an object of the present disclosure is to provide a technique capable of grasping how much power generated by renewable energy is held by a storage battery in a charging base in the future.

An information processing method according to one aspect of the present disclosure is an information processing method in a computer, including acquiring a remaining power amount of a storage battery included in a charging base and a designated time from a current time onward, acquiring a first actual value that is an actual value of charging power to the storage battery by renewable energy and a second actual value that is an actual value of discharging power from the storage battery, predicting a necessary power amount that is a charging amount of the storage battery in a period from the current time to the designated time based on the remaining power amount of the storage battery and the second actual value, predicting a renewable energy power amount, which is an amount of power by the renewable energy in the necessary power amount, based on the first actual value, and outputting a renewable energy rate that is a ratio of an amount of power by the renewable energy of the storage battery at the designated time based on the renewable energy power amount.

### BRIEF DESCRIPTION OF THE DRAWINGS

FIG. 1 is a diagram illustrating an overall configuration of an information processing system according to an embodiment of the present disclosure.

FIG. 2 is a diagram illustrating one example of a configuration of a server.

FIG. 3 is a flowchart illustrating one example of processing of the server according to a first embodiment.

FIG. 4 is a flowchart illustrating one example of processing of the server according to a second embodiment.

FIG. 5 is a diagram illustrating one example of a screen generated by a calculation unit in a third embodiment.

FIG. 6 is a flowchart illustrating one example of processing of the server according to a fourth embodiment.

FIG. 7 is a diagram illustrating one example of a screen generated by a calculation unit in the fourth embodiment.

### DETAILED DESCRIPTION

### Knowledge Underlying Present Disclosure

In recent years, there have been increasing charging stations (hereinafter, charging base) that charge storage batteries with electric power generated by renewable energy such as sunlight, geothermal heat, or wind power, and supply electric power held by the storage batteries to electric moving bodies. Along with this, for example, services for providing information regarding charging bases such as the position of the charging station, the number of electric moving bodies that can use the charging station, and the available time of the charging station via the Internet are also increasing. In addition, there is also a charging base that allows the user to select power to be supplied from the storage battery to the electric moving body.

For example, Patent Literature 1 describes a technique for providing a renewable energy rate of a storage battery in a charging station to an electric vehicle via a communication line. However, in the technique described in Patent Literature 1, it is possible to grasp the renewable energy currently held by the storage battery in the charging station, but it is not possible to grasp how much the storage battery in the charging station will hold the renewable energy in the future. Therefore, when the user arrives at the charging station, the amount of renewable energy held by the storage battery may be smaller than the amount expected by the user.

On the other hand, it is assumed that it is possible to grasp how much the storage battery in the charging base retains the power generated by the renewable energy in the future. In this case, the user of the electric moving body can select the charging base to be used and determine the timing to use the charging base in consideration of how much the storage battery holds the power generated by the renewable energy when arriving at the charging base. In the charging base, the life cycle CO₂ emission amount can be managed and reduced.

Therefore, the present inventor has intensively studied a technique capable of grasping how much power generated by renewable energy is held in the storage battery of the charging base in the future, and has arrived at each aspect of the present disclosure described below.

(1) An information processing method according to one aspect of the present disclosure is an information processing method in a computer, including acquiring a remaining power amount of a storage battery included in a charging base and a designated time from a current time onward, acquiring a first actual value that is an actual value of charging power to the storage battery by renewable energy and a second actual value that is an actual value of discharging power from the storage battery, predicting a necessary power amount that is a charging amount of the storage battery in a period from the current time to the designated time based on the remaining power amount of the storage battery and the second actual value, predicting a renewable energy power amount, which is an amount of power by the renewable energy in the necessary power amount, based on the first actual value, and outputting a renewable energy rate that is a ratio of an amount of power by the renewable energy of the storage battery at the designated time based on the renewable energy power amount.

In this configuration, the necessary power amount that is the charging amount of the storage battery in the period from the current time to the designated time is predicted based on the remaining power amount of the storage battery and the second actual value that is the actual value of the discharging power from the storage battery. Further, the renewable energy power amount, which is the amount of power by the renewable energy among the necessary power amount, is predicted based on the first actual value, which is the actual value of the charging power to the storage battery by the renewable energy. Therefore, the amount of power to be used for charging the storage battery in the future period can be predicted by dividing it into the amount of power from renewable energy and the amount of other power based on the renewable energy power amount.

In this configuration, the renewable energy rate of the storage battery at the designated time is output based on the predicted amount of power by the renewable energy used for charging the storage battery in the period. Therefore, according to the present configuration, it is possible to grasp how much the storage battery of the charging base holds the power generated by the renewable energy at the future designated time.

(2) The information processing method according to (1) may further include acquiring a renewable energy rate in a remaining power amount of the storage battery, and outputting a renewable energy rate of the storage battery at the designated time based on the renewable energy rate of the storage battery and the renewable energy power amount.

According to this configuration, since the renewable energy rate in the remaining power amount of the storage battery is acquired, it is possible to output an appropriate renewable energy rate of the storage battery at the designated time based on not only the renewable energy power amount but also the acquired renewable energy rate of the storage battery.

(3) The information processing method according to (1) may further include acquiring a purchase plan of grid power in the period, and predicting, in prediction of the renewable energy power amount, the renewable energy power amount based on the purchase plan and the first actual value.

According to this configuration, since the purchase plan of the grid power in the period is acquired, the renewable energy power amount can be appropriately predicted based not only on the first actual value but also on the acquired purchase plan of the grid power.

(4) The information processing method according to (3) may further include acquiring a number of chargeable moving bodies, which is a current number of electric moving bodies that can be charged at a same time by discharging from the storage battery, acquiring, in the acquiring of the second actual value, the second actual value when the number of chargeable moving bodies matches the current number of chargeable moving bodies, acquiring, in the acquiring of the purchase plan in the period, the purchase plan when the number of chargeable moving bodies in the period matches the current number of chargeable moving bodies, and preparing, when the renewable energy rate of the storage battery at the designated time is less than a predetermined target value, a plan for reducing the number of chargeable moving bodies in the period in such a way that the renewable energy rate of the storage battery at the designated time is equal to or greater than the target value.

In this configuration, a plan is prepared to reduce the number of chargeable moving bodies in the period so that the renewable energy rate of the storage battery in the designated time is equal to or greater than a predetermined target value. Therefore, according to the present configuration, in the charging base, by limiting the number of chargeable moving bodies in the period according to the prepared plan, the renewable energy rate of the storage battery at the designated time can be made equal to or higher than the target value.

(5) In the information processing method according to any one of (1) to (4), the charging base may include one or more first charging bases, and the method may further include acquiring a current location of a user and positions of the one or more first charging bases, and outputting, to a terminal device used by the user in the outputting, information indicating a screen on which a first map image displaying a current location of the user and positions of the one or more first charging bases is displayed and on which a renewable energy rate of the storage battery included in each of the one or more first charging bases at the designated time are displayed.

In this configuration, information indicating the screen on which the first map image displaying the current location of the user and the positions of the one or more first charging bases is displayed and on which the renewable energy rate of the storage battery of each of the one or more first charging bases at the designated time are displayed is output to the terminal device used by the user. Therefore, the user can easily grasp the position of the charging base where the renewable energy rate of the storage battery at the designated time is close to what the user desires by referring to the screen in the terminal device.

(6) The information processing method according to (5) may further include acquiring a current remaining power amount and a current renewable energy rate of a secondary battery included in an electric moving body used by the user, calculating a necessary charging amount that is an amount of power necessary for charging the secondary battery until a remaining power amount of the secondary battery reaches a predetermined target power amount, calculating a renewable energy rate of the storage battery included in each of the first charging bases at the designated time for the one or more first charging bases, and calculating, for the one or more first charging bases, a renewable energy rate of the secondary battery immediately after the secondary battery is charged by the necessary charging amount by discharge from the storage battery of each of the first charging bases, based on a remaining power amount and a renewable energy rate of the secondary battery, the necessary charging amount, and a renewable energy rate of the storage battery of each of the first charging bases at the designated time.

According to the present configuration, in each of the one or more first charging bases, when the secondary battery included in the electric moving body used by the user is charged by the necessary charging amount by the discharge from the storage battery of each first charging base, it is possible to manage how much power generated by the renewable energy is held by the secondary battery immediately after charging.

(7) The information processing method according to (6) may further include specifying one or more second charging bases in which a renewable energy rate of the secondary battery equal to or higher than a predetermined threshold is calculated among the one or more first charging bases, acquiring a current location of the user and positions of the one or more second charging bases, and outputting, to the terminal device in the outputting, information indicating a screen on which a second map image displaying a current location of the user and positions of the one or more second charging bases is displayed and on which a renewable energy rate of the storage battery included in each of the one or more second charging bases at the designated time are displayed.

In this configuration, the screen on which the second map image displaying the current location of the user and the positions of the one or more second charging bases is displayed and on which the renewable energy rate of the storage battery of each of the one or more second charging bases at the designated time are displayed is output to the terminal device used by the user. Therefore, by referring to the screen on the terminal device, the user can easily grasp the positions of one or more second charging bases that can make the renewable energy rate of the secondary battery equal to or higher than the predetermined threshold when the secondary battery is charged by the necessary charging amount at the designated time.

(8) The information processing method according to (1) may include predicting, in the predicting of the renewable energy power amount, a private power generation amount by the renewable energy in the period, and a charging amount to the storage battery by the renewable energy in the grid power in the period.

According to the present configuration, it is possible to predict the renewable energy power amount, which is the amount of power by the renewable energy in the necessary power amount, which is the amount of charge of the storage battery in the future period, separately by the private power generation amount by the renewable energy and the charging amount to the storage battery by the renewable energy in the grid power.

(9) An information processing device according to another aspect of the present disclosure includes a first acquisition unit that acquires a remaining power amount of a storage battery included in a charging base, a second acquisition unit that acquires a designated time from a current time onward, a third acquisition unit that acquires a first actual value that is an actual value of charging power to the storage battery by renewable energy and a second actual value that is an actual value of discharging power from the storage battery, a second prediction unit that predicts a necessary power amount that is a charging amount of the storage battery in a period from the current time to the designated time based on the remaining power amount of the storage battery and the second actual value, a first prediction unit that predicts a renewable energy power amount, which is an amount of power by the renewable energy in the necessary power amount, based on the first actual value, and an output unit that outputs a renewable energy rate that is a ratio of an amount of power by the renewable energy of the storage battery at the designated time based on the renewable energy power amount.

According to this configuration, the same operation and effect as those of the information processing method described in (1) can be obtained.

(10) A non-transitory computer readable storage medium according to still another aspect of the present disclosure is a non-transitory computer readable storage medium storing a control program for controlling a computer of an information processing device causes the computer to function as a first acquisition unit that acquires a remaining power amount of a storage battery included in a charging base, a second acquisition unit that acquires a designated time from a current time onward, a third acquisition unit that acquires a first actual value that is an actual value of charging power to the storage battery by renewable energy and a second actual value that is an actual value of discharging power from the storage battery, a second prediction unit that predicts a necessary power amount that is a charging amount of the storage battery in a period from the current time to the designated time based on the remaining power amount of the storage battery and the second actual value, a first prediction unit that predicts a renewable energy power amount, which is an amount of power by the renewable energy in the necessary power amount, based on the first actual value, and an output unit that outputs a renewable energy rate that is a ratio of an amount of power by the renewable energy of the storage battery at the designated time based on the renewable energy power amount.

According to this configuration, the same operation and effect as those of the information processing method described in (1) can be obtained.

The present disclosure can also be implemented as an information processing system that is operated by such a control program. It is needless to say that such a computer program can be distributed via a computer-readable non-transitory recording medium such as a CD-ROM or via a communication network such as the Internet.

Each of the embodiments described below illustrates a specific example of the present disclosure. Numerical values, shapes, constituents, steps, order of steps, and the like described in the embodiments below are merely examples, and are not intended to limit the present disclosure. A constituent element not described in an independent claim representing a highest concept among constituent elements in the embodiments below is described as an optional constituent element. In all the embodiments, respective contents can be combined.

### First Embodiment

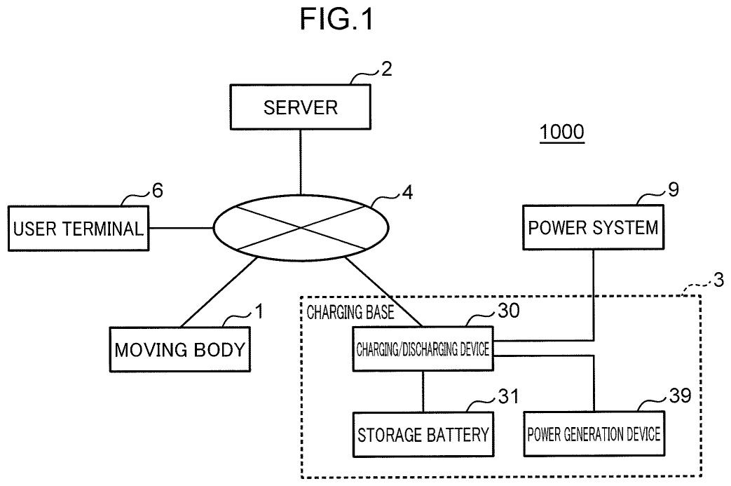

FIG. 1 is a diagram illustrating an overall configuration of an information processing system 1000 according to an embodiment of the present disclosure. The information processing system 1000 includes a server 2 (information processing device), a moving body 1 (electric moving body), a user terminal 6 (terminal device), and a charging base 3.

The server 2 is communicably connected to the moving body 1, the user terminal 6, and a charging/discharging device 30 included in the charging base 3 via a network 4. The network 4 is, for example, a wide-area communication network including the Internet and a mobile phone communication network. In FIG. 1, one moving body 1, one user terminal 6, and one charging/discharging device 30 are illustrated, but a plurality of these devices may be provided. Each of the moving body 1, the user terminal 6, and the charging/discharging device 30 is uniquely specified by a communication address.

The moving body 1 is mounted with a chargeable and dischargeable secondary battery, and travels using the power of the secondary battery as a power source. The moving body 1 is, for example, an electric car, an electric motorcycle, or the like. The secondary battery mounted on the moving body 1 is, for example, a chargeable and dischargeable secondary battery such as a lithium ion battery or a nickel hydrogen battery. The secondary battery of the moving body 1 is electrically connected to the charging/discharging device 30 by a charging cable not illustrated, and is charged by power (hereinafter, discharging power) discharged from the storage battery 31 under the control of the charging/discharging device 30.

The moving body 1 includes a display for displaying various information, a touch panel device for receiving various operations, a communication circuit for communicating with an external device via the network 4, and the like. The moving body 1 periodically transmits information regarding traveling (hereinafter, traveling information) to the server 2 using the communication circuit. The traveling information includes current date and time, identification information regarding the moving body 1, a current location and a traveling speed, a remaining power amount (state of charge (SOC)) of a secondary battery mounted on the moving body 1, and the like. Note that the moving body 1 may include a wireless communication circuit that performs near field wireless communication with the user terminal 6. In this case, the traveling information may be transmitted to the server 2 via the user terminal 6.

The user terminal 6 is used by the user of the information processing system 1000, for example, an information processing device such as a tablet computer and a smartphone. The user terminal 6 includes a display for displaying various information, a touch panel device for receiving various operations, a communication circuit for communicating with an external device via the network 4, and the like.

The user terminal 6 uses the communication circuit to communicate various types of information with the charging/discharging device 30 and an external device such as the server 2. Furthermore, the user terminal 6 may include a near field wireless communication circuit that performs near field wireless communication with the moving body 1. In this case, the user terminal 6 may transmit the traveling information acquired by the near field wireless communication with the moving body 1 to the server 2 using the communication circuit.

The charging base 3 includes a power generation device 39, a charging/discharging device 30, and a storage battery 31. Although one charging base 3 is illustrated in FIG. 1, a plurality of the charging bases 3 may be provided. In addition, in FIG. 1, one storage battery 31 and one power generation device 39 are illustrated in one charging base 3, but a plurality of storage batteries 31 and a plurality of power generation devices 39 may be included in one charging base 3.

The power generation device 39 supplies power (hereinafter, private power generation) generated using renewable energy to the charging/discharging device 30. The renewable energy is, for example, sunlight, geothermal heat, wind power, or the like.

The charging/discharging device 30 charges the storage battery 31 with electric power purchased from a power system 9 (hereinafter, grid power) and private power generation generated by the power generation device 39. The storage battery 31 is, for example, a chargeable and dischargeable secondary battery such as a lithium ion battery.

The charging/discharging device 30 includes a measuring instrument that measures a remaining power amount of the storage battery 31, power charged in the storage battery 31, power discharged from the storage battery 31, and the like. The charging/discharging device 30 further includes a display for displaying various information, a touch panel device for receiving various operations, a communication circuit for communicating with an external device via the network 4, and the like.

The charging/discharging device 30 is configured to be able to simultaneously charge the number of moving bodies 1 equal to or smaller than a predetermined upper limit number by the discharging power discharged from the storage battery 31. Specifically, one ends of charging cables (not illustrated) as many as the upper limit number are electrically connected to the charging/discharging device 30. When the other end of each charging cable is electrically connected to the secondary battery mounted on the moving body 1, the charging/discharging device 30 discharges the power held by the storage battery 31 to the secondary battery via each charging cable. As a result, the secondary battery connected to the other end of each charging cable is charged by the discharging power discharged from the storage battery 31.

The charging/discharging device 30 manages a remaining power amount of the storage battery 31 by dividing the remaining power amount into a remaining power amount based on renewable energy and a remaining power amount based on grid power. The charging/discharging device 30 manages a renewable energy rate of the storage battery 31. The renewable energy rate of the storage battery 31 is a ratio of the remaining power amount based on the renewable energy to the remaining power amount of the storage battery 31.

Specifically, every time the storage battery 31 is charged by the grid power immediately after the storage battery 31 is installed, the charging/discharging device 30 calculates an integrated value of the amount of power charged in the storage battery 31 by the grid power. Similarly, the charging/discharging device 30 calculates an integrated value of the amount of power charged in the storage battery 31 by the private power generation every time the storage battery 31 is charged by the private power generation is terminated immediately after the storage battery 31 is installed. The charging/discharging device 30 calculates a result obtained by dividing the integrated value of the amount of power charged in the storage battery 31 based on the private power generation by the sum of the integrated value of the amount of power charged in the storage battery 31 based on the grid power and the integrated value of the amount of power charged in the storage battery 31 based on the private power generation as the renewable energy rate of the storage battery 31.

On the other hand, every time the discharge is performed from the storage battery 31 to the moving body 1, the charging/discharging device 30 subtracts a product of the amount of power discharged to the moving body 1 and the renewable energy rate of the storage battery 31 from an integrated value of the amount of power charged to the storage battery 31 by the private power generation, as the amount of power of the private power generation discharged from the storage battery 31. Similarly, every time when the discharge is performed from the storage battery 31 to the moving body 1, the charging/discharging device 30 calculates the product of the amount of power discharged to the moving body 1 and a result (1—renewable energy rate of the storage battery 31) obtained by subtracting the renewable energy rate of the storage battery 31 from 1. The charging/discharging device 30 subtracts the product from the integrated value of the amount of power charged in the storage battery 31 by the grid power as the amount of power of the grid power discharged from the storage battery 31.

The charging/discharging device 30 periodically transmits information regarding the state of the storage battery 31 (hereinafter, storage battery information) to the server 2 using the communication circuit. Specifically, the storage battery information includes, for example, current date and time, identification information of the charging base 3 including the charging/discharging device 30, identification information of the charging/discharging device 30, identification information of the storage battery 31, a remaining power amount of the storage battery 31, a renewable energy rate of the storage battery 31, and the number of moving bodies 1 that can be simultaneously charged by discharge from the storage battery 31 (hereinafter, the number of chargeable moving bodies).

Note that the charging/discharging device 30 may acquire information indicating the current weather from a predetermined weather server using a communication circuit at a predetermined timing such as every hour, for example. Accordingly, the charging/discharging device 30 may include weather information acquired most recently in the charge information and the discharge information.

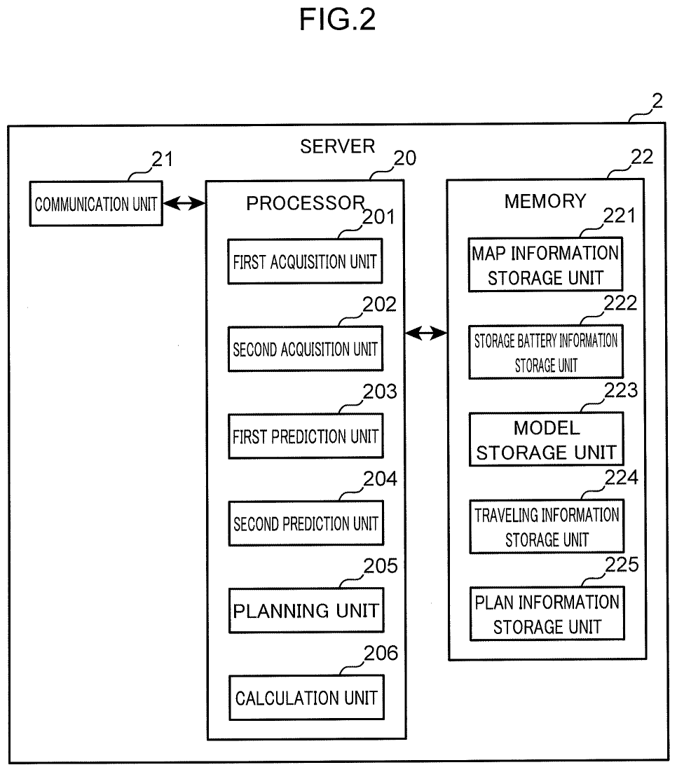

Next, a configuration of the server 2 will be described in detail. FIG. 2 is a diagram illustrating one example of a configuration of the server 2. The server 2 includes a communication unit 21, a memory 22, and a processor 20 (computer).

The communication unit 21 is a communication circuit that connects the server 2 to the network 4. The communication unit 21 receives traveling information from the moving body 1 or the user terminal 6. The communication unit 21 receives storage battery information from the charging/discharging device 30.

The memory 22 includes, for example, a nonvolatile rewritable semiconductor memory such as a flash memory, a hard disk drive (HDD), or the like. The memory 22 stores a control program executed by the processor 20. The memory 22 includes a map information storage unit 221, a storage battery information storage unit 222, a model storage unit 223, a traveling information storage unit 224, and a plan information storage unit 225.

The map information storage unit 221 stores information (hereinafter, map information) about each spot in a predetermined area. Each spot in the area is the charging base 3, facilities such as parks and schools present in the area, and characteristic spots on roads such as intersections and end points of the roads present in the area. The map information includes a map image indicating a map of the area and information indicating positions of the respective spots in the area. The information indicating the positions of the spots includes latitudes and longitudes of the spots. Note that the information indicating the positions of the spots may further include altitudes of the spots.

The storage battery information storage unit 222 stores the storage battery information transmitted from the charging/discharging device 30 to the server 2.

The model storage unit 223 stores learned models used for various types of processing executed by the processor 20.

For example, the model storage unit 223 stores a first model obtained by machine learning of the relationship between the actual value at the time when the storage battery 31 is charged by the private power generation generated by the power generation device 39 and the actual value of the private power generation used for charging the storage battery 31 at the time. When the time is input, the first model outputs an estimated value of the private power generation used for charging the storage battery 31 at the time.

Note that the first model may be obtained by machine learning of the relationship between the actual value at the time when the storage battery 31 is charged by the private power generation, the actual value of the information indicating the weather at the time, and the actual value of the private power generation used for charging the storage battery 31 at the time. In this case, when the time and the information indicating the weather at the time are input, the first model outputs the estimated value of the private power generation used for charging the storage battery 31 at the time.

The model storage unit 223 stores a second model obtained by machine learning the relationship between the actual value at the time when the discharge from the storage battery 31 to the moving body 1 has been performed and the actual value of the discharging power discharged from the storage battery 31 at the time. When a time is input, the second model outputs an estimated value of discharging power discharged from the storage battery 31 at the time.

The traveling information storage unit 224 stores traveling information transmitted by the moving body 1 or the user terminal 6. The traveling information storage unit 224 further stores information (hereinafter, user information) associating the identification information of the moving body 1, the identification information of the secondary battery mounted on the moving body 1, the amount of power (hereinafter, fully charged power amount) held when the secondary battery is in the fully charged state, the identification information of the user of the moving body 1, and the identification information of the user terminal 6 used by the user.

The plan information storage unit 225 stores information (hereinafter, plan information) indicating a plan (hereinafter, purchase plan) in which the charging base 3 purchases grid power from the power system 9 (FIG. 1). The purchase plan includes a date and time when the charging base 3 receives supply of the grid power purchased from the power system 9 and information regarding the grid power purchased from the power system 9 at the date and time. The information regarding the grid power includes a power value of the grid power, a purchase price, and the like.

The processor 20 includes, for example, a central processing unit. The processor 20 executes the control program stored in the memory 22 to function as a first acquisition unit 201, a second acquisition unit 202, a first prediction unit 203 (third acquisition unit, first prediction unit), a second prediction unit 204 (third acquisition unit, second prediction unit), a planning unit 205 (fourth acquisition unit), and a calculation unit 206 (calculation unit, output unit). However, this is an example, and the first acquisition unit 201, the second acquisition unit 202, the first prediction unit 203, the second prediction unit 204, the planning unit 205, and the calculation unit 206 may be realized by a dedicated electric circuit such as ASIC.

The first acquisition unit 201 acquires the remaining power amount and the renewable energy rate of the storage battery 31. Specifically, the first acquisition unit 201 acquires the remaining power amount and the renewable energy rate of the storage battery 31 from the storage battery information stored in the storage battery information storage unit 222. For example, the first acquisition unit 201 acquires the remaining power amount and the renewable energy rate of the storage battery 31 included in the battery information including the latest current date and time stored in the storage battery information storage unit 222 as the current remaining power amount and the current renewable energy rate of the storage battery 31.

The second acquisition unit 202 acquires a designated time from the current time onward. Specifically, in the user terminal 6, when the user performs a predetermined operation for transmitting the request information, the user terminal 6 transmits the request information to the server 2. The request information is information for requesting the server 2 to calculate the renewable energy rate of the storage battery 31 at a designated time from the current time onward. The request information includes the current location of the user terminal 6, the identification information of the user terminal 6, the identification information of the user who uses the user terminal 6, and the designated time.

When the communication unit 21 receives the request information from the user terminal 6, the second acquisition unit 202 acquires the designated time included in the request information. The method by which the second acquisition unit 202 acquires the designated time is not limited thereto. For example, the second acquisition unit 202 may acquire a time when a predetermined elapsed time has elapsed from the current time as the designated time.

The first prediction unit 203 acquires an actual value (hereinafter, first actual value) of the private power generation by renewable energy. The private power generation by the renewable energy is power (charging power) generated by the power generation device 39 and used for charging the storage battery 31. The first prediction unit 203 predicts a private power generation amount by the renewable energy in a period (hereinafter, the first period) from the current time to the designated time acquired by the second acquisition unit 202 based on the first actual value. Details of the first prediction unit 203 will be described later.

The second prediction unit 204 acquires the actual value (hereinafter, second actual value) of the discharging power from the storage battery 31. The second prediction unit 204 predicts the charging amount (hereinafter, necessary power amount) of the storage battery 31 in the first period, which is the amount of power necessary for discharge from the storage battery 31 in the first period, based on the current renewable energy rate of the storage battery 31 and the second actual value acquired by the first acquisition unit 201.

Specifically, based on the current renewable energy rate of the storage battery 31 and the second actual value acquired by the first acquisition unit 201, the second prediction unit 204 predicts the amount of power of the private power generation necessary for discharging from the storage battery 31 in the first period among the necessary power amounts and the amount of power of the grid power necessary for discharging from the storage battery 31 in the first period among the necessary power amounts. Hereinafter, the amount of power of the private power generation necessary for the discharge from the storage battery 31 is referred to as a necessary private power generation amount. The amount of power of the grid power necessary for discharging from the storage battery 31 is referred to as a necessary grid power amount. Details of the second prediction unit 204 will be described later.

The planning unit 205 acquires the plan information stored in the plan information storage unit 225. As described above, the plan information is information indicating the purchase plan of the grid power purchased from the power system 9 by the charging base 3. The purchase plan includes a date and time when the charging base 3 receives supply of the grid power purchased from the power system 9 and information regarding the grid power purchased from the power system 9 at the date and time. The planning unit 205 calculates the amount of power of the grid power to be purchased in the first period with reference to the purchase plan indicated by the plan information. Hereinafter, the amount of power of the grid power purchased in the first period is referred to as a purchased power amount in the first period.

The calculation unit 206 calculates the renewable energy rate of the storage battery 31 at the designated time based on the current remaining power amount and the current renewable energy rate of the storage battery 31 acquired by the first acquisition unit 201, the private power generation amount by the renewable energy in the first period predicted by the first prediction unit 203, the necessary private power generation amount and the necessary grid power amount in the first period predicted by the second prediction unit 204, and the purchased power amount in the first period calculated by the planning unit 205. The calculation unit 206 outputs the calculated renewable energy rate of the storage battery 31 at the designated time. Details of the calculation unit 206 will be described later.

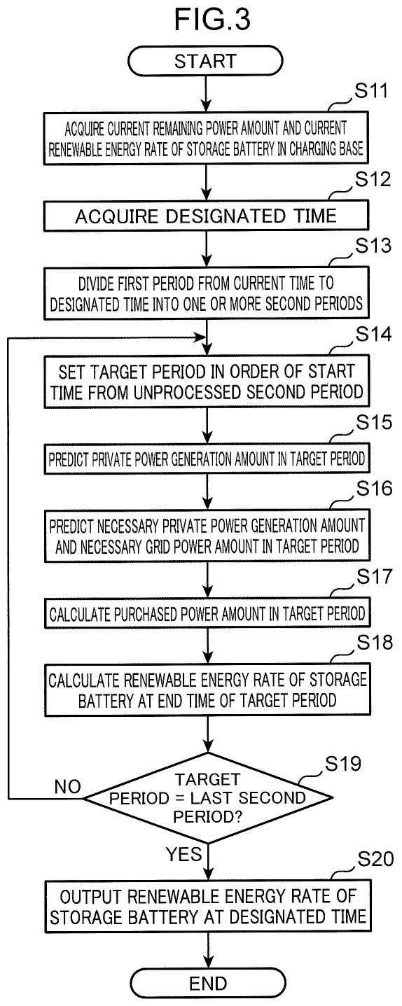

The configuration of the server 2 has been described above. Subsequently, processing of the server 2 will be described. In the present description, details of the first prediction unit 203, the second prediction unit 204, and the calculation unit 206 will be described. FIG. 3 is a flowchart illustrating one example of the processing of the server 2 according to the first embodiment. When the communication unit 21 receives the request information from the user terminal 6, the processor 20 starts the processing illustrated in FIG. 3.

In step S11, the first acquisition unit 201 acquires the remaining power amount and the renewable energy rate of the storage battery 31 of the current charging base 3.

In step S12, the second acquisition unit 202 acquires a designated time from the current time onward.

In step S13, the calculation unit 206 divides the first period from the current time to the designated time acquired in step S12 into one or more second periods. The lengths of the second periods may or may not be the same. In addition, the calculation unit 206 may set the first period as one second period.

In step S14, the calculation unit 206 extracts one second period from the unprocessed second periods included in the first period in the order of the earliest start time, and sets the one second period as a target period of processing for predicting the renewable energy rate of the storage battery 31. The unprocessed second period is a second period in which the renewable energy rate of the storage battery 31 is not predicted.

In step S15, the first prediction unit 203 acquires a first actual value that is an actual value of private power generation by the renewable energy, and predicts the private power generation amount by the renewable energy in the target period based on the first actual value.

Specifically, in step S15, the first prediction unit 203 acquires, from the model storage unit 223 as the first actual value, the first model obtained by machine learning the relationship between the actual value at the time when the storage battery 31 is charged by the private power generation generated by the power generation device 39 and the actual value of the private power generation used for charging the storage battery 31 at the time. As described above, when the time is input, the first model outputs an estimated value of the private power generation used for charging the storage battery 31 at the time. When the start time of the target period is input to the first model, the first prediction unit 203 acquires the estimated value of the private power generation output by the first model. The first prediction unit 203 calculates the product of the acquired estimated value and the length of the target period as the private power generation amount in the target period.

Next, in step S16, the second prediction unit 204 predicts the necessary private power generation amount (the amount of power of the private power generation necessary for the discharge from the storage battery 31) and the necessary grid power amount (the amount of power of the grid power necessary for the discharge from the storage battery 31) in the target period based on the second actual value that is the actual value of the discharging power from the storage battery 31.

Specifically, in step S16, the second prediction unit 204 acquires, from the model storage unit 223 as the second actual value, the second model obtained by machine learning the relationship between the actual value at the time when the discharge from the storage battery 31 to the moving body 1 has been performed and the actual value of the discharging power discharged from the storage battery 31 at the time. As described above, when a time is input, the second model outputs an estimated value of discharging power discharged from the storage battery 31 at the time. The second prediction unit 204 acquires the estimated value of the discharging power output from the second model when the start time of the target period is input to the second model.

The second prediction unit 204 calculates the product of the acquired estimated value, the renewable energy rate of the storage battery 31 at the start time of the target period, and the length of the target period as the necessary private power generation amount in the target period. On the other hand, the second prediction unit 204 calculates the product of the acquired estimated value, a result (1—renewable energy rate) obtained by subtracting the renewable energy rate of the storage battery 31 at the start time of the target period from 1, and the length of the target period as the necessary grid power amount in the target period.

When the target period is the second period having the earliest start time, the second prediction unit 204 uses the current renewable energy rate of the storage battery 31 acquired in step S11 as the renewable energy rate of the storage battery 31 at the start time of the target period. When the target period is different from the second period having the earliest start time, the second prediction unit 204 uses the renewable energy rate of the storage battery 31 predicted in the latest step S18 as the renewable energy rate of the storage battery 31 at the start time of the target period.

In step S17, the planning unit 205 acquires the plan information stored in the plan information storage unit 225, refers to the purchase plan indicated by the plan information, and calculates the amount of power (hereinafter, purchased power amount in target period) of the grid power to be purchased in the target period.

In step S18, the calculation unit 206 calculates the renewable energy rate of the storage battery 31 at the end time of the target period based on the current remaining power amount and the current renewable energy rate of the storage battery 31 acquired in step S11, and the private power generation amount, the purchased power amount, the necessary private power generation amount, and the necessary grid power amount in the target period predicted and calculated in steps S15 to S17.

Specifically, in step S18, when the target period is the second period having the earliest start time among the one or more second periods, the calculation unit 206 calculates the renewable energy rate of the storage battery 31 at the end time of the target period as follows.

The calculation unit 206 calculates the product of the current remaining power amount of the storage battery 31 acquired in step S11 and the current renewable energy rate of the storage battery 31 as the power amount (hereinafter, start-time private power generation amount) of the private power generation charged in the storage battery 31 at the start time of the target period.

In addition, the calculation unit 206 calculates the product of the remaining power amount of the storage battery 31 acquired in step S11 and the result (1—renewable energy rate) obtained by subtracting the renewable energy rate of the storage battery 31 from 1 as the power amount (hereinafter, start-time grid power amount) of the grid power charged in the storage battery 31 at the start time of the target period.

The calculation unit 206 calculates the sum of the start-time private power generation amount and the private power generation amount in the target period predicted in step S15 (=start-time private power generation amount+private power generation amount in the target period). The calculation unit 206 calculates a result obtained by subtracting the necessary private power generation amount in the target period predicted in step S16 from the sum (=start-time private power generation amount+private power generation amount in the target period necessary private power generation amount in the target period) as the power amount (hereinafter, end-time private power generation amount) of the private power generation charged in the storage battery 31 at the end time of the target period.

On the other hand, the calculation unit 206 calculates the sum of the start-time grid power amount and the purchased power amount in the target period calculated in step S17 (=start-time grid power amount+purchased power amount in the target period). The calculation unit 206 calculates a result obtained by subtracting the necessary grid power amount in the target period predicted in step S16 from the sum (=start-time grid power amount+purchased power amount in the target period-necessary grid power amount in the target period) as the power amount (hereinafter, end-time grid power amount) of the grid power charged in the storage battery 31 at the end time of the target period.

The calculation unit 206 calculates a result obtained by dividing the end-time private power generation amount by the sum of the end-time private power generation amount and the end-time grid power amount (=end-time private power generation amount/(end-time private power generation amount+end-time grid power amount)) as the renewable energy rate of the storage battery 31 at the end time of the target period.

When the target period is not the second period having the earliest start time among the one or more second periods, the calculation unit 206 calculates the renewable energy rate of the storage battery 31 at the end time of the target period in the same manner as described above using the end-time private power generation amount calculated in the previous step S18 as the start-time private power generation amount and using the end-time grid power amount calculated in the previous step S18 as the start-time grid power amount.

Next, in step S19, the calculation unit 206 determines whether the target period is a second period (hereinafter, the last second period) having the latest start time among the one or more second periods. When it is determined in step S19 that the target period is not the last second period (NO in step S19), the processes in and after step S14 are performed again.

On the other hand, when it is determined in step S19 that the target period is the last second period (YES in step S19), in step S20, the calculation unit 206 outputs the renewable energy rate of the storage battery 31 at the end time of the target period calculated in the latest step S18 as the renewable energy rate of the storage battery 31 at the designated time.

For example, in step S20, the calculation unit 206 returns information including the renewable energy rate of the storage battery 31 at the designated time to the user terminal 6 that has transmitted the request information. When step S20 ends, the processor 20 ends the processing illustrated in FIG. 3.

As described above, according to the first embodiment, the private power generation amount by the renewable energy in the first period from the current time to the designated time is predicted, and the purchased power amount in the first period, which is the power amount of the grid power purchased in the first period, is calculated. Further, the necessary private power generation amount, which is the private power generation amount necessary for the discharge from the storage battery 31 in the first period, and the necessary grid power amount, which is the power amount of the grid power necessary for the discharge from the storage battery 31 in the first period, are predicted. Therefore, according to the first embodiment, the amount of power used for charging and discharging of the storage battery 31 in the future first period can be grasped by dividing it into the private power generation amount from renewable energy and the amount of power of the grid power.

In this configuration, the renewable energy rate of the storage battery 31 at the designated time is calculated and output based on the current renewable energy rate and remaining power amount of the storage battery 31 and the private power generation amount, the purchase plan, the necessary private power generation amount, and the necessary grid power amount in the first period. Therefore, it is possible to grasp how much the storage battery 31 of the charging base 3 holds the power self-generated by the renewable energy at the future designated time.

Note that step S17 may be omitted. Accordingly, in step S18, the calculation unit 206 may calculate the end-time grid power amount assuming that the purchased power amount in the target period is 0.

When the storage battery information transmitted by the charging/discharging device 30 does not include the renewable energy rate of the storage battery 31, the calculation unit 206 may output the renewable energy rate of the storage battery 31 at the designated time as follows.

Specifically, the first acquisition unit 201 acquires the remaining power amount of the storage battery 31 of the current charging base 3, similarly to step S11. Similarly to step S12, the second acquisition unit 202 acquires the designated time from the current time onward. Next, as in step S15, when the start time of the first period is input to the first model, the first prediction unit 203 calculates the product of the estimated value of the private power generation output by the first model and the length of the first period as the private power generation amount in the first period.

Next, as in step S16, the second prediction unit 204 calculates the product of the estimated value of the discharging power output from the second model when the start time of the first period is input to the second model and the length of the first period as the necessary power amount in the first period. Then, the calculation unit 206 outputs the renewable energy rate of the necessary power amount in the first period, which is a result obtained by dividing the private power generation amount in the first period calculated by the first prediction unit 203 by the necessary power amount in the first period calculated by the second prediction unit 204, as the renewable energy rate of the storage battery 31 at the designated time, that is, the end time of the first period. In this case, as the renewable energy rate of the storage battery 31 at the designated time, the renewable energy rate of the amount of power to be charged (necessary power amount) can be output. The calculation unit 206 may output the renewable energy rate of the necessary power amount in the first period calculated in this manner together with the renewable energy rate of the storage battery 31 at the designated time in step S20 described above.

### Second Embodiment

In the first embodiment, an example has been described in which the renewable energy rate of the storage battery 31 at the designated time is output without considering the number of chargeable moving bodies, which is the number of moving bodies 1 that can be simultaneously charged by discharge from the storage battery 31. In the second embodiment, an example will be described in which a renewable energy rate of the storage battery 31 at a designated time is calculated in consideration of the number of chargeable moving bodies, and a plan for reducing the number of chargeable moving bodies is prepared so that the renewable energy rate is equal to or greater than a predetermined target value.

In the second embodiment, the second model is obtained by machine learning of the relationship between the actual value at the time when the discharge from the storage battery 31 to the moving body 1 is performed, the actual value of the discharging power discharged from the storage battery 31 at the time, and the actual value of the number of chargeable moving bodies at the time. When the time and the number of chargeable moving bodies at the time are input, the second model outputs an estimated value of discharging power discharged from the storage battery 31 at the time.

In the second embodiment, the plan information includes a purchase plan when the number of chargeable moving bodies is each the upper limit number or less. For example, in a case where the upper limit number is two, the plan information includes a purchase plan when the number of chargeable moving bodies is two, a purchase plan when the number of chargeable moving bodies is one, and a purchase plan when the number of chargeable moving bodies is zero.

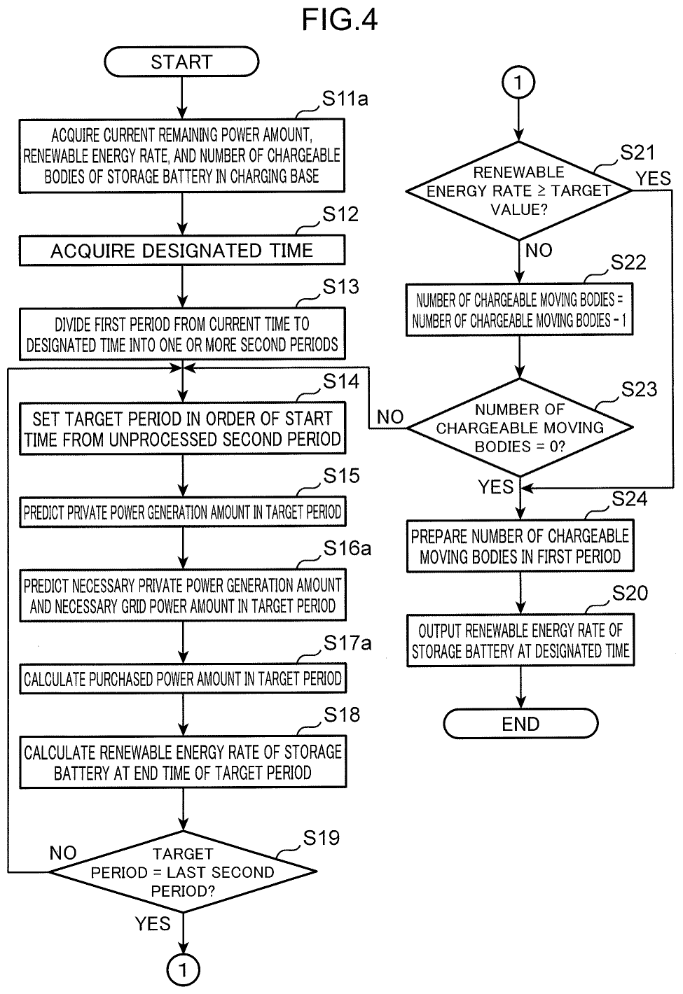

Hereinafter, processing of the server 2 in the second embodiment will be described in detail. Note that in the following description, the same components as those in the first embodiment are denoted by the same reference numerals, and description thereof will be omitted. FIG. 4 is a flowchart illustrating one example of the processing of the server 2 according to the second embodiment. In the second embodiment, when the communication unit 21 receives request information from the user terminal 6, the processor 20 starts the processing illustrated in FIG. 4.

When the processing illustrated in FIG. 4 is started, in step S11a, the first acquisition unit 201 acquires not only the current remaining power amount and the current renewable energy rate of the storage battery 31 of the charging base 3 but also the current number of chargeable moving bodies, which is the number of moving bodies 1 that can be simultaneously charged by discharging from the storage battery 31.

Specifically, in step S11a, the first acquisition unit 201 acquires the remaining power amount and renewable energy rate of the storage battery 31, and the number of chargeable moving bodies from the storage battery information including the latest current date and time stored in the storage battery information storage unit 222.

After step S15, in step S16a, the second prediction unit 204 predicts the necessary private power generation amount and the necessary grid power amount in the target period based on the actual value of the discharging power from the storage battery 31 when the number of chargeable moving bodies matches the current number of chargeable moving bodies acquired in step S11a.

Specifically, in step S16a, the second prediction unit 204 acquires, from the model storage unit 223, a second model obtained by machine learning the relationship among the actual value at the time when the discharge from the storage battery 31 to the moving body 1 is performed, the actual value of the discharging power discharged from the storage battery 31 at the time, and the actual value of the number of chargeable moving bodies at the time, as the second actual value when the number of chargeable moving bodies matches the current number of chargeable moving bodies acquired in step S11a.

As described above, in the second embodiment, when a time and the number of chargeable moving bodies at the time are input, the second model outputs an estimated value of discharging power discharged from the storage battery 31 at the time. When the start time of the target period and the current number of chargeable moving bodies acquired in step S11a are input to the second model, the second prediction unit 204 acquires an estimated value of the discharging power output from the second model.

Thereafter, similarly to the first embodiment, the second prediction unit 204 calculates the product of the acquired estimated value, the renewable energy rate of the storage battery 31 at the start time of the target period, and the length of the target period as the necessary private power generation amount in the target period. On the other hand, the second prediction unit 204 calculates the product of the acquired estimated value, a result (1—renewable energy rate) obtained by subtracting the renewable energy rate of the storage battery 31 at the start time of the target period from 1, and the length of the target period as the necessary grid power amount in the target period.

After step S16a, in step S17a, the planning unit 205 acquires, from the plan information stored in the plan information storage unit 225, a purchase plan when the number of chargeable moving bodies matches the number of chargeable moving bodies acquired in step S11a. The planning unit 205 calculates the purchased power amount in the target period with reference to the purchase plan.

It is assumed that it is determined in step S19 that the target period is the last second period (YES in step S19). In this case, in step S21, the calculation unit 206 determines whether the renewable energy rate of the storage battery 31 calculated in the most recent step S18 is a predetermined target value or more.

When determining that the renewable energy rate of the storage battery 31 is less than the predetermined target value in step S21 (NO in step S21), the calculation unit 206 decreases the number of chargeable moving bodies by one in step S22.

If the number of chargeable moving bodies that has been reduced in step S22 is not 0 (NO in step S23), the processing in and after step S14 is performed again. In the processing in and after step S14 to be performed again, in step S16a and step S17a, the number of chargeable moving bodies after the decrease in step S22 is used instead of the number of chargeable moving bodies acquired in step S11a. Note that, in the processing after step S14 to be performed again, step S15 is processing that does not depend on the number of chargeable moving bodies, and thus may be omitted.

When it is determined in step S21 that the renewable energy rate of the storage battery 31 is equal to or higher than the predetermined target value (YES in step S21), and when the number of chargeable moving bodies after the decrease in step S22 is 0 (YES in step S23), the processing in and after step S24 is performed.

In step S24, the calculation unit 206 prepares a plan to set the number of chargeable moving bodies of the storage battery 31 in the first period from the current time to the designated time to the number of chargeable moving bodies used in the latest steps S16a and S17a.

Specifically, in step S24, the calculation unit 206 uses the communication unit 21 to transmit, to the charging/discharging device 30, an instruction to set the number of chargeable moving bodies of the storage battery 31 in the first period to the number of chargeable moving bodies used in the latest steps S16a and S17a. Upon receiving the instruction, the charging/discharging device 30 limits the number of moving bodies 1 that can be simultaneously charged by discharging from the storage battery 31 to the instructed number of chargeable moving bodies during the first period according to the instruction.

After step S24, step S20 is performed.

In the second embodiment, a plan is prepared to reduce the number of chargeable moving bodies in the first period so that the renewable energy rate of the storage battery 31 in the designated time is equal to or greater than a predetermined target value. Therefore, in the charging base 3, by limiting the number of chargeable moving bodies in the first period according to the prepared plan, the renewable energy rate of the storage battery 31 at the designated time can be made equal to or higher than the predetermined target value.

### Third Embodiment

In the third embodiment, as in the first or second embodiment, for the storage battery 31 included in each of the one or more charging bases 3 included in the information processing system 1000, an example will be described in which the renewable energy rate of the storage battery 31 at the designated time is calculated and output to the user terminal 6.

Specifically, in the third embodiment, when the communication unit 21 receives the request information from the user terminal 6, the processor 20 acquires the current location of the user terminal 6 included in the request information. The processor 20 refers to the map information stored in the map information storage unit 221 and specifies one or more charging bases 3 (hereinafter, one or more first charging bases) existing at a position within a predetermined distance from the current location of the user terminal 6.

The processor 20 performs the processing illustrated in FIG. 3 or 4 on the storage battery 31 included in each of the one or more first charging bases. In the third embodiment, in step S20, the calculation unit 206 stores the renewable energy rate of the storage battery 31 of each first charging base at the end time of the target period calculated in the latest step S18 in the memory 22 as the renewable energy rate of the storage battery 31 of each first charging base at the designated time.

Furthermore, the calculation unit 206 acquires the current location of the user terminal 6 acquired by the processor 20 as the current location of the user. The calculation unit 206 acquires a map image including the current location of the user and the positions of one or more first charging bases from the map information storage unit 221. The calculation unit 206 generates a map image (first map image) in which the current location of the user and the positions of one or more first charging bases are displayed on the map image. The calculation unit 206 generates information indicating a screen displaying the map image and the renewable energy rate of the storage battery 31 of each of the one or more charging bases 3 at the designated time stored in the memory 22. The calculation unit 206 returns information indicating the screen to the user terminal 6 that has transmitted the request information.

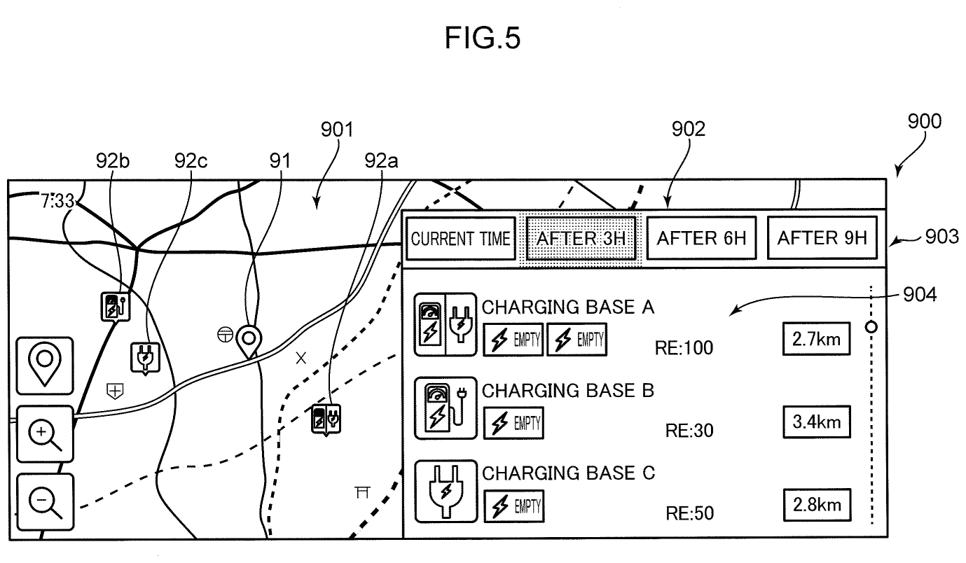

FIG. 5 is a diagram illustrating an example of a screen 900 generated by the calculation unit 206 in the third embodiment. For example, the calculation unit 206 generates information indicating the screen 900 illustrated in FIG. 5, and returns the information to the user terminal 6 that has transmitted the request information. Upon receiving the information indicating the screen 900, the user terminal 6 displays the screen 900 on its own display.

The screen 900 includes a map image 901 (first map image) and a time selection screen 902. The map image 901 illustrates an example in which a current location 91 of the user, a position 92a of the first charging base “charging base A”, a position 92b of the first charging base “charging base B”, and a position 92c of the first charging base “charging base C” are displayed on a map image including the current location of the user and positions of one or more first charging bases.

The time selection screen 902 includes a tab area 903 for allowing the user to select an elapsed time from the current time and a display area 904. In the display area 904, the time when the elapsed time selected in the tab area 903 has elapsed from the current time is set as a designated time, and the renewable energy rate of the storage battery 31 of each first charging base at the designated time is displayed.

Specifically, when the elapsed time from the current time is selected in the tab area 903, the user terminal 6 sets the time at which the selected elapsed time has elapsed from the current time as the designated time, and transmits request information including the designated time to the server 2. As a result, in the server 2, the renewable energy rate of the storage battery 31 included in each of the one or more first charging bases at the designated time is calculated, and the renewable energy rate is displayed in the display area 904.

FIG. 5 illustrates an example in which the elapsed time “after 3H” from the current time is selected in the tab area 903. FIG. 5 illustrates an example in which the renewable energy rate “RE: 100” of the storage battery 31 of the first charging base “charging base A”, the renewable energy rate “RE: 30” of the storage battery 31 of the first charging base “charging base B”, and the renewable energy rate “RE: 50” of the storage battery 31 of the first charging base “charging base C” at the same time as the elapsed time “after 3H” elapses from the current time are displayed in the display area 904.

In the third embodiment, information indicating the screen 900 on which the map image 901 on which the current location 91 of the user and the positions 92a to 92c of the one or more first charging bases are displayed and the renewable energy rate of the storage battery 31 of each of the one or more first charging bases at the designated time are displayed is output to the user terminal 6. Therefore, the user can easily grasp the position of the charging base 3 where the renewable energy rate of the storage battery 31 at the designated time is close to what the user desires by referring to the screen 900 in the user terminal 6.

### Fourth Embodiment

In the fourth embodiment, an example will be described in which, when the secondary battery of the moving body 1 used by the user is charged with the discharging power discharged from the storage battery 31 of each of the one or more first charging bases, the renewable energy rate of the secondary battery at the time immediately after the charging is calculated. In addition, an example of outputting, to the user terminal 6, information indicating a screen related to one or more second charging bases in which a renewable energy rate of a secondary battery equal to or greater than a predetermined threshold is calculated among the one or more first charging bases will be described.

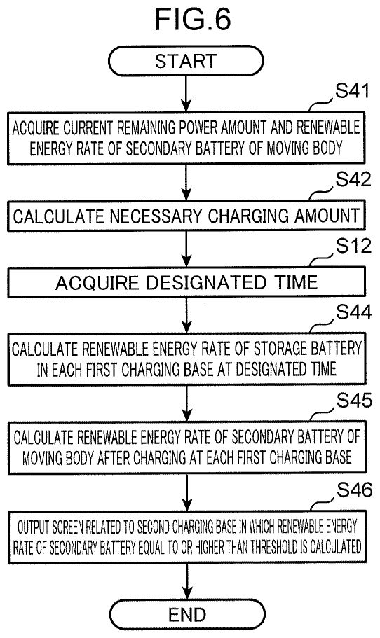

FIG. 6 is a flowchart illustrating one example of the processing of the server 2 according to the fourth embodiment. In the fourth embodiment, when the communication unit 21 receives request information from the user terminal 6, the processor 20 starts the processing illustrated in FIG. 6.

In step S41, the first acquisition unit 201 acquires the remaining power amount and the renewable energy rate of the secondary battery mounted on the moving body 1 used by the user. Hereinafter, the secondary battery mounted on the moving body 1 used by the user will be abbreviated as the secondary battery of the moving body 1.

Specifically, in the fourth embodiment, the moving body 1 is configured to be able to manage the renewable energy rate of the secondary battery of the moving body 1 at the current time. The traveling information periodically transmitted from the moving body 1 to the server 2 includes the renewable energy rate of the secondary battery.

In step S41, the first acquisition unit 201 refers to the user information stored in the traveling information storage unit 224, and acquires the identification information of the moving body 1 used by the user of the user terminal 6 that has transmitted the request information. The first acquisition unit 201 acquires traveling information including the acquired identification information of the moving body 1 and the latest current date and time from the traveling information storage unit 224. The first acquisition unit 201 acquires the remaining power amount and the renewable energy rate of the secondary battery of the moving body 1 included in the traveling information acquired from the traveling information storage unit 224.

In step S42, the calculation unit 206 calculates the amount of power necessary for charging the secondary battery (hereinafter, necessary charging amount) until the remaining power amount of the secondary battery of the moving body 1 reaches a predetermined target power amount.

Specifically, the target power amount is determined in advance as, for example, a fully charged power amount held when the secondary battery of the moving body 1 is in a fully charged state. In this case, in step S42, the calculation unit 206 acquires the fully charged power amount of the secondary battery of the moving body 1 from the user information stored in the traveling information storage unit 224. The target power amount is not limited thereto, and may be included in the request information transmitted by the user terminal 6. In this case, the calculation unit 206 acquires the target power amount from the request information.

The calculation unit 206 calculates a result obtained by subtracting the remaining power amount of the secondary battery acquired in step S41 from the target power amount (=target power amount-remaining power amount of the secondary battery) as the necessary charging amount.

Next, as in the first or second embodiment, in step S12, the second acquisition unit 202 acquires the designated time from the current time onward.

Next, in step S44, similarly to the third embodiment, the processor 20 specifies one or more first charging bases existing at positions within a predetermined distance from the current location of the user terminal 6, and performs the processing illustrated in FIG. 3 or 4 on the storage battery 31 included in each of the one or more first charging bases. As a result, the renewable energy rate of the storage battery 31 included in each of the one or more first charging bases at the designated time is calculated.

Next, in step S45, the calculation unit 206 calculates, for one or more first charging bases, the renewable energy rate of the secondary battery immediately after the charging when the secondary battery of the moving body 1 is charged by the necessary charging amount with the discharging power from the storage battery 31 of each first charging base.

Specifically, in step S45, the calculation unit 206 calculates the product (=remaining power amount of the secondary battery×renewable energy rate of the secondary battery) of the remaining power amount and the renewable energy rate of the secondary battery of the moving body 1 acquired in step S41. Hereinafter, the product is referred to as a first product. As a result, the calculation unit 206 calculates the amount of power of the private power generation currently held by the secondary battery of the moving body 1.

Next, the calculation unit 206 calculates the product (=renewable energy rate of the storage battery 31 in each first charging base×necessary charging amount) of the renewable energy rate of the storage battery 31 in each first charging base and the necessary charging amount calculated in step S42, which are acquired in step S11 (FIG. 3) or step S11a (FIG. 4) and included in the processing illustrated in FIGS. 3 or 4 performed in step S44. Hereinafter, the product is referred to as a second product. As a result, when charging the secondary battery of the moving body 1 by the necessary charging amount, the calculation unit 206 calculates the power amount of the private power generation discharged from the storage battery 31 of each first charging base to the secondary battery of the moving body 1.

The calculation unit 206 divides the sum of the first product and the second product (=remaining power amount of the secondary battery×renewable energy rate of the secondary battery+renewable energy rate of the storage battery 31 of each first charging base×necessary charging amount) by the fully charged power amount of the secondary battery of the moving body 1.

The calculation unit 206 calculates the result of the division (=(remaining power amount of secondary battery×renewable energy rate of the secondary battery+renewable energy rate of the storage battery 31 included in each first charging base×necessary charging amount)/fully charged power amount of the secondary battery) as the renewable energy rate of the secondary battery immediately after charging when the secondary battery of the moving body 1 is charged by the necessary charging amount with the discharging power from the storage battery 31 of each first charging base.

In step S46, the calculation unit 206 specifies, among the one or more first charging bases, one or more second charging bases in which the renewable energy rate of the secondary battery equal to or greater than the predetermined threshold is calculated. Similarly to the third embodiment, the calculation unit 206 outputs information indicating a screen related to the one or more second charging bases to the user terminal 6 that has transmitted the request information.

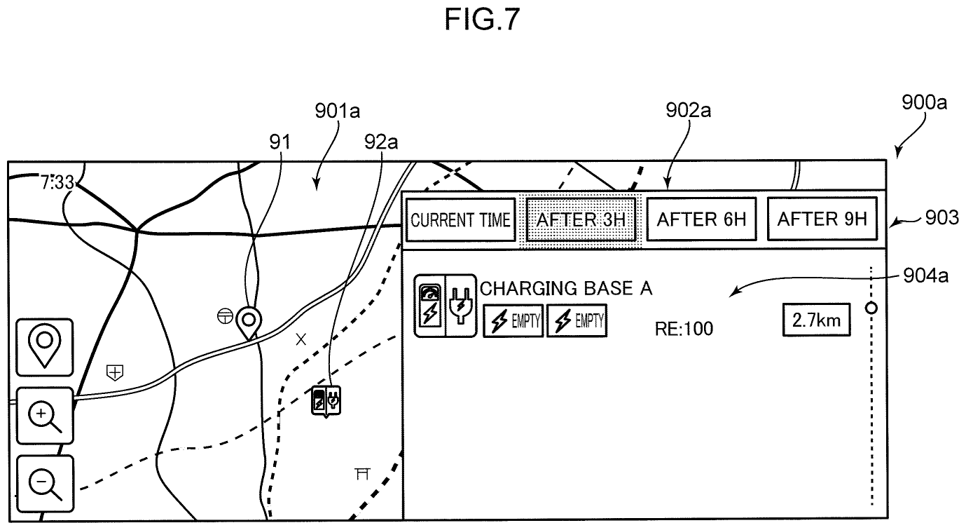

FIG. 7 is a diagram illustrating an example of a screen 900a generated by the calculation unit 206 in the fourth embodiment. For example, in step S46, the calculation unit 206 generates information indicating the screen 900a illustrated in FIG. 7, and returns the information to the user terminal 6 that has transmitted the request information. Upon receiving the information indicating the screen 900a, the user terminal 6 displays the screen 900a on its own display.

The screen 900a includes a map image 901a (second map image) and a time selection screen 902a. The map image 901a illustrates an example in which the current location 91 of the user and the position 92a of the second charging base “charging base A” are displayed on a map image including the current location of the user and the positions of one or more second charging bases.

The time selection screen 902a includes a tab area 903 similar to that in FIG. 5 and a display area 904a. In the display area 904a, the time when the elapsed time selected in the tab area 903 has elapsed from the current time is set as a designated time, and the renewable energy rate of the storage battery 31 of each second charging base at the designated time is displayed.

Specifically, when the elapsed time from the current time is selected in the tab area 903, the user terminal 6 sets the time at which the selected elapsed time has elapsed from the current time as the designated time, and transmits request information including the designated time to the server 2. As a result, in the server 2, the renewable energy rate of the storage battery 31 included in each of the one or more first charging bases at the designated time is calculated. In addition, for one or more first charging bases, when the secondary battery of the moving body 1 is charged by the necessary charging amount with the discharging power from the storage battery 31 of each first charging base, the renewable energy rate of the secondary battery immediately after the charging is calculated. Among the one or more first charging bases, one or more second charging bases in which the renewable energy rate of the secondary battery equal to or higher than the predetermined threshold is calculated are specified, and the renewable energy rate of the storage battery 31 of each of the one or more second charging bases is displayed in the display area 904a.

A tab area 903 in FIG. 7 illustrates an example in which the elapsed time “after 3H” from the current time is selected. The display area 904a of FIG. 7 illustrates an example in which a second charging base “charging base A” that sets the renewable energy rate of the secondary battery of the moving body 1 immediately after the necessary power amount is charged to a predetermined threshold value or more is specified from among the three first charging bases “charging base A”, “charging base B”, and “charging base C” illustrated in FIG. 5. In addition, the display area 904a in FIG. 7 illustrates an example in which the renewable energy rate “RE: 100” of the storage battery 31 of the second charging base “charging base A” at the time when the elapsed time “after 3H” has elapsed from the current time is displayed.

According to the fourth embodiment, by referring to the screen 900a on the user terminal 6, the user of the moving body 1 can easily grasp the positions of one or more second charging bases capable of setting the renewable energy rate of the secondary battery to be equal to or higher than the predetermined threshold when the secondary battery of the moving body 1 is charged by the necessary charging amount with the discharging power from the storage battery 31 of each second charging base at the designated time.

In the first to fourth embodiments, it has been described that the charging base 3 is a charging station. However, the charging base 3 is not limited to the charging station as long as the charging base 3 includes at least a storage battery and is configured to be able to charge the storage battery with renewable energy. The charging base 3 may be, for example, one or more electric moving bodies each having a storage battery, or may be a house having a stationary storage battery in addition to a facility such as a factory having a stationary storage battery. Even in these cases, the charging base 3 is normally configured to be able to supply the power held by the storage battery of the charging base 3 to another storage battery or an electric device.

In addition, when the grid power purchased by the charging base 3 includes power based on renewable energy, and the renewable energy rate in the grid power is clear, the charging base 3 does not necessarily have facilities for private power generation including the power generation device 39. In this case, the amount of power by renewable energy among the grid power calculated based on the renewable energy rate of the grid power corresponds to the private power generation amount in the first to fourth embodiments.

In addition, the grid power may be supplied from a plurality of power systems 9. For example, power with a renewable energy rate of 100% may be purchased as grid power from one power system 9, and power with an unknown renewable energy rate may be purchased as grid power from another power system 9. Even in this case, the amount of power based on the renewable energy calculated based on the amount of grid power purchased from one power system 9 and the renewable energy rate of the grid power (100% in the above example) corresponds to the private power generation amount in the first to fourth embodiments.

According to the present disclosure, it is possible to grasp how much power generated using renewable energy is held in the storage battery in the charging base in the future. Therefore, the present disclosure is useful for determining which charging base a user uses and when, and is also useful for managing a life cycle CO₂ emission amount in the charging base.

1. An information processing method in a computer, comprising:
acquiring a remaining power amount of a storage battery included in a charging base and a designated time from a current time onward;
acquiring a first actual value that is an actual value of charging power to the storage battery by renewable energy and a second actual value that is an actual value of discharging power from the storage battery;
predicting a necessary power amount that is a charging amount of the storage battery in a period from the current time to the designated time based on the remaining power amount of the storage battery and the second actual value;
predicting a renewable energy power amount, which is an amount of power by the renewable energy in the necessary power amount, based on the first actual value; and
outputting a renewable energy rate that is a ratio of an amount of power by the renewable energy of the storage battery at the designated time based on the renewable energy power amount.

2. The information processing method according to claim 1, further comprising:
acquiring a renewable energy rate in a remaining power amount of the storage battery; and
outputting a renewable energy rate of the storage battery at the designated time based on the renewable energy rate of the storage battery and the renewable energy power amount.

3. The information processing method according to claim 1, further comprising:
acquiring a purchase plan of grid power in the period; and
predicting, in prediction of the renewable energy power amount, the renewable energy power amount based on the purchase plan and the first actual value.

4. The information processing method according to claim 3, further comprising:
acquiring a number of chargeable moving bodies, which is a current number of electric moving bodies that can be charged at a same time by discharging from the storage battery;
acquiring, in the acquiring of the second actual value, the second actual value when the number of chargeable moving bodies matches the current number of chargeable moving bodies;
acquiring, in the acquiring of the purchase plan in the period, the purchase plan when the number of chargeable moving bodies in the period matches the current number of chargeable moving bodies; and
preparing, when the renewable energy rate of the storage battery at the designated time is less than a predetermined target value, a plan for reducing the number of chargeable moving bodies in the period in such a way that the renewable energy rate of the storage battery at the designated time is equal to or greater than the target value.

5. The information processing method according to claim 1, wherein
the charging base includes one or more first charging bases, and
the method further comprises:
acquiring a current location of a user and positions of the one or more first charging bases; and
outputting, to a terminal device used by the user in the outputting, information indicating a screen on which a first map image displaying a current location of the user and positions of the one or more first charging bases is displayed and on which a renewable energy rate of the storage battery included in each of the one or more first charging bases at the designated time are displayed.

6. The information processing method according to claim 5, further comprising:
acquiring a current remaining power amount and a current renewable energy rate of a secondary battery included in an electric moving body used by the user;
calculating a necessary charging amount that is an amount of power necessary for charging the secondary battery until a remaining power amount of the secondary battery reaches a predetermined target power amount;
calculating a renewable energy rate of the storage battery included in each of the first charging bases at the designated time for the one or more first charging bases; and
calculating, for the one or more first charging bases, a renewable energy rate of the secondary battery immediately after the secondary battery is charged by the necessary charging amount by discharge from the storage battery of each of the first charging bases, based on a remaining power amount and a renewable energy rate of the secondary battery, the necessary charging amount, and a renewable energy rate of the storage battery of each of the first charging bases at the designated time.

7. The information processing method according to claim 6, further comprising:
specifying one or more second charging bases in which a renewable energy rate of the secondary battery equal to or higher than a predetermined threshold is calculated among the one or more first charging bases;
acquiring a current location of the user and positions of the one or more second charging bases; and
outputting, to the terminal device in the outputting, information indicating a screen on which a second map image displaying a current location of the user and positions of the one or more second charging bases is displayed and on which a renewable energy rate of the storage battery included in each of the one or more second charging bases at the designated time are displayed.

8. The information processing method according to claim 1, comprising:
predicting, in the predicting of the renewable energy power amount, a private power generation amount by the renewable energy in the period, and a charging amount to the storage battery by the renewable energy in the grid power in the period.

9. An information processing device, comprising:
a first acquisition unit that acquires a remaining power amount of a storage battery included in a charging base;
a second acquisition unit that acquires a designated time from a current time onward;
a third acquisition unit that acquires a first actual value that is an actual value of charging power to the storage battery by renewable energy and a second actual value that is an actual value of discharging power from the storage battery;
a second prediction unit that predicts a necessary power amount that is a charging amount of the storage battery in a period from the current time to the designated time based on the remaining power amount of the storage battery and the second actual value;
a first prediction unit that predicts a renewable energy power amount, which is an amount of power by the renewable energy in the necessary power amount, based on the first actual value; and
an output unit that outputs a renewable energy rate that is a ratio of an amount of power by the renewable energy of the storage battery at the designated time based on the renewable energy power amount.

10. A non-transitory computer readable storage medium storing a control program for controlling a computer of an information processing device, the control program causing the computer to function as:
a first acquisition unit that acquires a remaining power amount of a storage battery included in a charging base;
a second acquisition unit that acquires a designated time from a current time onward;
a third acquisition unit that acquires a first actual value that is an actual value of charging power to the storage battery by renewable energy and a second actual value that is an actual value of discharging power from the storage battery;
a second prediction unit that predicts a necessary power amount that is a charging amount of the storage battery in a period from the current time to the designated time based on the remaining power amount of the storage battery and the second actual value;
a first prediction unit that predicts a renewable energy power amount, which is an amount of power by the renewable energy in the necessary power amount, based on the first actual value; and
an output unit that outputs a renewable energy rate that is a ratio of an amount of power by the renewable energy of the storage battery at the designated time based on the renewable energy power amount.
